(19) United States
(12) Patent Application Publication
(10) Pub. No.: US 2021/0130975 A1
(43) Pub. Date: May 6, 2021

(54) TREATING ALLOY SUBSTRATES HAVING OXIDIZED LAYERS

(71) Applicant: Hewlett-Packard Development Company, L.P., Spring, TX (US)

(72) Inventors: Kuan-Ting Wu, Taipei City (TW); Chalam Kashyap, Fort Collins, CO (US)

(73) Assignee: Hewlett-Packard Development Company, L.P., Spring, TX (US)

(21) Appl. No.: 16/605,052

(22) PCT Filed: Apr. 13, 2017
(86) PCT No.: PCT/US2017/027352

§ 371 Date: Oct. 14, 2019

(51) Int. Cl. C25D 11/24; C01G 23/08; C23C 26/00; C23C 28/04

(52) U.S. Cl. CPC C25D 11/246; C01G 23/08; C01P 2004/64; C23C 28/04; C23C 26/00

(57) ABSTRACT

The present subject matter relates to treating alloy substrates having oxidized layers. An anodized alloy substrate is contacted with an alkaline mixture including titanium to form a processed substrate. The anodized alloy substrate includes an oxidized layer on its surface. The processed substrate is baked to form a finished substrate. The finished substrate includes titanium dioxide particles in the oxidized layer.

### BACKGROUND

Substrates of alloys may be provided with an oxidized layer on their surfaces to improve their corrosion resistance, appearance, hardness, wear resistance, glue-ability, paint adhesion, and other properties. The alloy substrates having oxidized layers find use in various applications. For example, an aluminum alloy substrate having an oxidized layer is used for making casings of electronic devices, such as smartphones, tablet computers, and laptop computers. The oxidized layer can be provided on the alloy substrates by an anodization, process.

### BRIEF DESCRIPTION OF DRAWINGS

The following detailed description references the figures, wherein:

FIG. 1 illustrates a method for treating an anodized alloy substrate, according to an example implementation of the present subject matter.

FIG. 2 illustrates a treatment of an anodized alloy substrate using a slurry including titanium dioxide (TiO₂) nano-particles, according to an example implementation of the present subject matter.

FIG. 3 illustrates a method for treatment of an alloy substrate, according to an example implementation of the present subject matter,

FIG. 4 illustrates treatment of an alloy substrate using a titanium compound solution, according to an example implementation of the present subject matter.

### DETAILED DESCRIPTION

Alloy substrates, such as aluminum alloy substrates, may be anodized to form an oxidized layer on the surface. Anodization involves placing an alloy substrate as an electrode in an electrolyte and applying an electric potential between the alloy substrate and another electrode. For example, anodization of an aluminum alloy substrate may involve placing the aluminum alloy substrate as an anode in an acidic electrolyte and applying electric potential between the aluminum alloy substrate and another electrode, which acts as the cathode.

Some alloys, such as aluminum 6013 (Al 6013) alloy, upon anodizing, become colored and develop a reflective surface. This colored and reflective surface renders these alloys unsuitable for use in various applications, such as in casings of electronic devices. Sometimes, such alloys that become colored and reflective upon anodization have superior properties. For example, the Al 6013 alloy has a higher tensile strength compared to other aluminum alloys, such as Al 6063, which are used for making the casings of electronic devices. Therefore, despite superior strength, the alloy may have limited use in venous applications, owing to the colored and reflective surface.

The present subject matter relates to treating alloy substrates having oxidized layers, one example being an anodized aluminum substrate. Implementations of the present subject matter enhance the whiteness of the alloy substrates having oxidized layers and also reduce their reflective nature.

In accordance with an example implementation of the present subject matter, an anodized alloy substrate is contacted with an alkaline mixture including titanium to form a processed substrate. The anodized alloy substrate includes an oxidized layer on its surface. The processed substrate is then baked to form a finished substrate, which includes titanium dioxide particles in the oxidized layer.

In an example, the alkaline mixture is a slurry including titanium dioxide nano-particles. The anodized alloy substrate is immersed in the alkaline mixture to deposit titanium dioxide nano-particles in a plurality of pores in the oxidized layer.

In another example, the alkaline mixture is a titanium compound solution. When the anodized aluminum substrate is immersed in the titanium compound solution, the anodized aluminum substrate is sealed. The immersing can cause deposition of titanium metal complexes and titanium dioxide particles from the titanium compound, solution in a plurality of pores, in the oxidized layer. Thereafter, the anodized aluminum substrate may be baked to form the finished substrate.

The deposition of titanium dioxide particles in the oxidized layer enhances the whiteness of the anodized alloy substrate and also makes it substantially non-reflective. As would be noted, the present subject matter can be used for treating anodized alloy substrates, such as anodized substrate of Al 6013, to render them suitable for making casings of electronic devices. Further, since the surface of the oxidized layer of the anodized, alloy is acidic due to having been in contact with an acidic electrolyte during anodization, the deposition of titanium metal complexes or titanium dioxide nano-particles from an alkaline solution in the oxidized layer is fast and substantially uniform. Therefore, the present subject matter provides a simple, effective, and passive method of forming titanium dioxide particles in the oxidized layer of the anodized alloy substrate.

The following description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

Example implementations of the present subject matter are described with regard to depositing titanium dioxide particles in an anodized aluminum alloy substrate. Although not described, it will be understood that the implementations of the present subject matter can be used with other anodized alloy substrates.

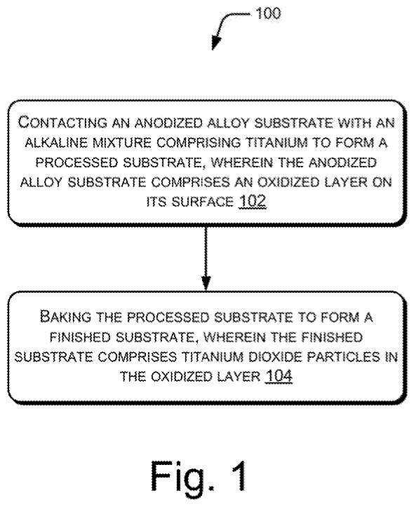

FIG. 1 illustrates a method 100 for treating an anodized alloy substrate, according to an example implementation of the present subject matter.

At block 102, an anodized alloy substrate is contacted with an alkaline mixture including titanium. The anodized alloy substrate includes an oxidized layer on its surface due to anodization. The alloy substrate that is anodized may be, for example, an aluminum alloy substrate. The aluminum alloy may be a 2000, 3000, 5000, 6000, or 7000 series aluminum alloy. In an example, the alloy substrate is an Al 6013 alloy substrate. Further, the alkaline mixture including titanium may have a pH in a range of about 8-12.

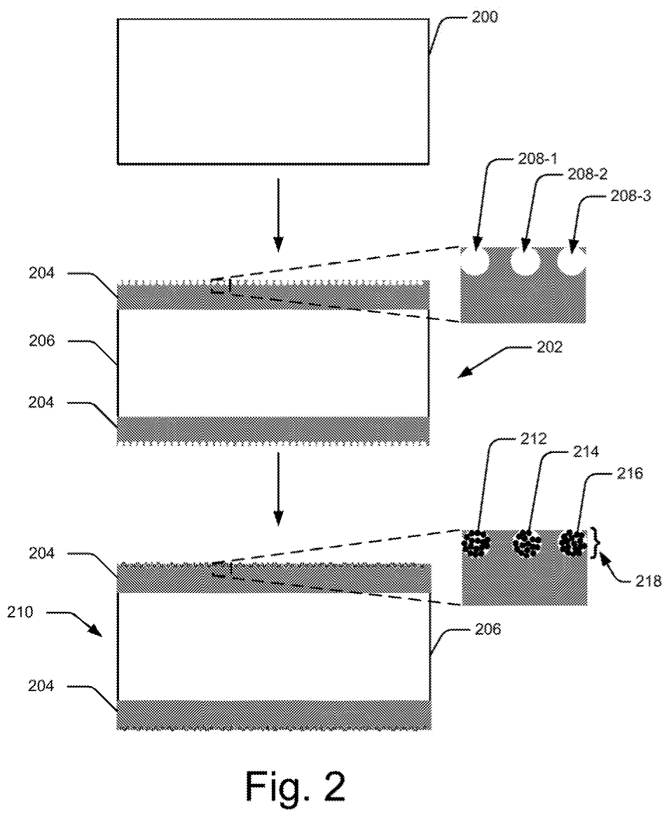

In an implementation, the alkaline mixture including titanium is a slurry including titanium dioxide (TiO₂) nano-particles. In accordance with the implementation, the anodized alloy substrate is contacted with the alkaline mixture by immersing the anodized alloy substrate in the slurry. In an example, the slurry includes TiO₂ nano-particles in a weight percentage range of about 5-75%. The slurry can also include at least one dispersing agent in a weight percentage range of about 0.1-2%. The deposition of the TiO₂ nano-particles from the slurry will be explained in greater detail with reference to FIG. 2.

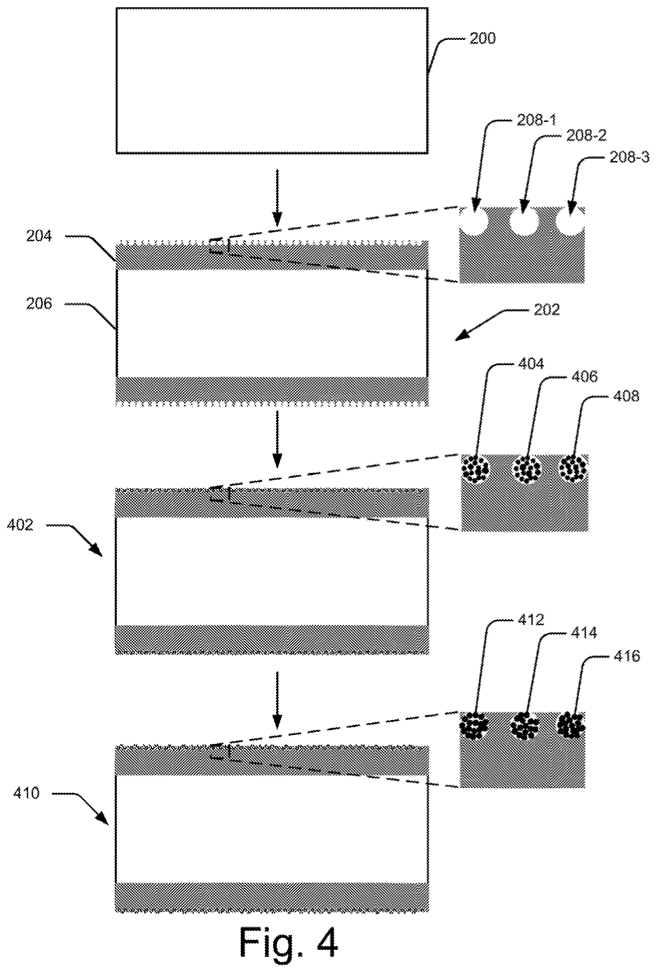

In another implementation, the alkaline mixture including titanium is a titanium compound solution. In accordance with the implementation, the contacting of the anodized alloy substrate with the alkaline mixture involves immersing the anodized alloy substrate in the titanium compound solution, which results in the sealing the plurality of pores in the oxidized layer using the titanium compound solution. The titanium compound solution may include at least one titanium compound in a weight percentage range of about 1-30%. The titanium compound solution may also include at least one alkaline agent in a weight percentage range of about 0.1-10%. The sealing of the plurality of pores in the oxidized layer using the titanium compound solution will be explained in greater detail with reference to FIG. 4.

In a further implementation, the contacting of an anodized alloy substrate with an alkaline mixture may be effected by spray coating an alkaline solution including titanium dioxide on the anodized alloy substrate. In an example, the alkaline solution includes a base, such as sodium hydroxide or potassium hydroxide, in a weight percentage range of about 1-10%, a dispersant, such as sodium polyacrylate, sodium silicate, or sodium phosphate, in a weight percentage range of about 0.1-2%, and titanium dioxide particles in a weight percentage range of about 5-30%. The titanium dioxide particles may have an original size of about 2 μm, and upon solubilizing in the alkaline solution, may have a size of about 20 nm or lower.

The contacting of alloy substrate with the alkaline mixture forms a processed substrate.

At block 104, the processed substrate is baked to form a finished substrate. The finished substrate includes titanium dioxide (TiO₂) particles in or on the oxidized layer. While it is explained that the titanium dioxide particles are present in the oxidized layer in the description and the claims, it is to be understood that the titanium dioxide particles may be present on the oxidized layer as well. Further, the portions of the specification teaching the presence of titanium dioxide particles in the oxidized layer, are intended to cover the presence of titanium dioxide particles on the oxidized layer as well.

FIG. 2 illustrates a treatment of an anodized alloy substrate using a slurry including TiO₂ nano-particles, according to an example implementation of the present subject matter.

An alloy substrate 200 may be anodized to form an anodized alloy substrate 202. The anodized alloy substrate 202 includes an oxidized layer 204 as a result of the anodization. Further, the anodized alloy substrate 202 includes a residual alloy portion 206. which is the portion of the alloy substrate 200 that remains un-oxidized after the anodization. The anodization results in the formation of a plurality of pores in the oxidized layer 204. For example, the oxidized layer 204 includes pores 208-1, 208-2, and 208-3. In an example, each of the plurality of pores have a diameter, also referred to as pore size, in a range of about 5-30 nm.

Titanium dioxide (TiO₂) nano-particles from the slurry including titanium dioxide nano-particles, interchangeably referred to as the slurry, are deposited in the plurality of pores in the surface of the anodized alloy substrate 202. In an example, the slurry includes TiO₂ nano-particles in a weight percentage range of about 5-75%. In an example, the TiO₂ nano-particles have a size in a range of 3-50 nm.

in addition the TiO₂ nano-particles, the slurry can also include at least one dispersing agent. in an example, the at least one dispersing agent is present in the slurry in a weight percentage range of about 0.1-2%, The dispersing agent enables retention of the TiO₂ nano-particles in the plurality of pores by forming a bond with both the ions in the oxidized layer 204, such as Al³⁺ ions, and the TiO₂ nano-particles. In an example, the at least one dispersing agent is selected from the group consisting of sodium silicate, sodium hexametaphosphate, sodium phosphate, sodium polyacrylate, and combinations thereof. As will be understood, the TiO₂ nano-particles are held in the plurality of pores by strong attractive forces, thereby ensuring that the TiO₂ nano-particles are retained in the plurality of pores.

The slurry including the TiO₂ nano-particles is alkaline in nature. In an example, the slurry has a pH in the range of about 8-9.5. Further, the anodized alloy substrate 202 is acidic in nature, as the anodization of the alloy substrate 200 is performed in an acidic environment, i.e., using an acidic electrolyte. Therefore, the deposition of the TiO₂ nano-particles in the plurality of pores is rapid due to an acid-base reaction, Further, a large number of the TiO₂ nano-particles are deposited. Therefore, the present subject matter enables a rapid deposition of a large number of TiO₂ nano-particles in the plurality of pores of the anodized alloy substrate 202 without utilizing complex techniques, such as electrolysis. in other words, the present subject matter provides a simple, efficient, effective, and passive method of depositing TiO₂ nano-particles in the plurality of pores.

In an implementation, the deposition of the TiO₂ nano-particles in the plurality of pores involves immersing the anodized alloy substrate 202 in the slurry, Since several TiO₂ nano-particles in the slurry have a size that is smaller than that of the plurality of pores, the TiO₂ nano-particles from the slurry enter the plurality of pores and get deposited in the plurality of pores to provide a processed substrate 210. As illustrated, the processed substrate 210 includes a plurality of TiO₂ nano-particles, such as TiO₂ nano-particles 212, 214, and 216 in the pores 208-1, 208-2, and 208-3, respectively.

In an example, the thickness of the residual alloy portion 206 in the processed substrate 210 is in a range of about 0.1-2 mm. Further, an outer layer 218 in the oxidized layer 204 having the plurality of pores and the TiO₂ nano-particles may span a thickness in a range of about 10-300 nm. Also, the remaining portion of the oxidized layer 204 (excluding the outer layer 218 may have a thickness in a range of about 5-25 μm.

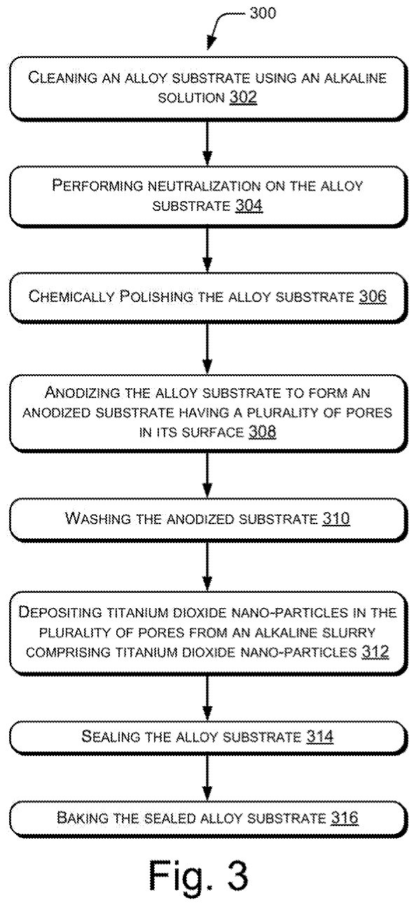

Upon depositing the TiO₂ nano-particles in the plurality of pores, the processed substrate 210 can be sealed and subsequently baked. Further, prior to anodizing, the alloy substrate 200 may be pre-treated. The pre-treatment, baking, and sealing are explained with reference to FIG. 3.

FIG. 3 illustrates a method 300 for treatment of an alloy substrate, according to an example implementation of the present subject matter.

At block 302, an alloy substrate, such as the alloy substrate 200, is cleaned using an alkaline solution, The alkaline solution can include bases, such as, sodium hydroxide, potassium hydroxide and ammonia.

At block 304, the cleaned alloy substrate is neutralized using an acidic solution. The neutralization neutralizes the bases on the surface of the alloy substrate. The acidic solution used for the neutralization can be, for example, hydrochloric acid and nitric acid.

At block 306, the alloy substrate is chemically polished. The polishing can be performed using, for example, phosphoric acid, nitric acid, sulfuric acid or a combination thereof.

At block 308, the alloy substrate is anodized, as explained with reference to FIG. 2. In an example, the anodization is performed at a voltage in a range of 10-120 V for a time period in a range of about 40-50 minutes. As mentioned earlier, the anodization of the alloy substrate forms the anodized alloy substrate, such as the anodized alloy substrate 202.

At block 310, the anodized alloy substrate is washed using water,

At block 312, TiO₂ nano-particles are deposited in a plurality of pores in the surface of the anodized alloy substrate from an alkaline slurry including TiO₂ nano-particles, as explained with reference to FIG. 2.

At block 314, the alloy substrate is sealed. The sealing of the alloy substrate seals the plurality of pores, prevents the anodized alloy surface from being sticky, and makes it non-absorbent to dirt, grease, oil, stains, and the like.

The sealing can be, for example, a hot water sealing or a chemical sealing. Further, the sealing may also remove large-sized titanium dioxide nano-particles that are unable to enter the plurality of pores from the surface of the alloy substrate. In an example, the sealing is performed in a solution including 0.6-5.0 of nickel acetate and nickel fluoride as sealing agents at a temperature of about 25-95° C. for a time period of about 10-20 minutes.

At block 316, the sealed alloy substrate is baked. In an example, the baking is performed at a temperature in a range of about 105-110° C. for a time period in a range of about 20-40 minutes.

In the methods described above with reference to FIGS. 2 and 3, the titanium dioxide particles are deposited in the anodized alloy substrate through an alkaline slurry of titanium dioxide particles. As mentioned earlier, in another implementation, the titanium dioxide particles may be deposited using an alkaline titanium compound solution.

FIG. 4 illustrates treatment of the alloy substrate 200 using a titanium compound solution, according to an example implementation of the present subject matter.

The oxidized layer 204 may be formed on the surface of the alloy substrate 200 by electrolytic oxidation. The electrolytic oxidation can be, for example, anodization, as explained at block 308. Prior to the electrolytic oxidation, the alloy substrate 200 may be pre-treated using the steps mentioned at blocks 302-306. The electrolytic oxidation converts the alloy substrate 200 into the anodized alloy substrate 202. As explained earlier, the oxidized layer 204 includes a plurality of pores. such as the pores 208-1, 208-2, and 208-3. Pursuant to the electrolytic oxidation, the alloy substrate 200 may be washed using water.

The plurality of pores is then sealed using a titanium compound solution. The titanium compound solution includes at least one titanium compound selected from the group consisting of titanium dioxide, titanium hydroxide, titanium phosphate, titanium metal complex, and combinations thereof. The titanium compound solution may include the at least one titanium compound in a weight percentage range of about 1-30%. If the titanium compound solution includes titanium dioxide particles, the titanium dioxide particles may have a reduced size because of solubilizing in the titanium, compound solution. In an example, prior to solubilizing, the titanium dioxide particles have a size of about 2 μm, and after solubilizing, the titanium dioxide particles have a size less than 20 nm.

The sealing of the plurality of pores using the titanium compound solution involves immersing the anodized alloy substrate 202 in the titanium compound solution. For the sealing to happen, in addition to the at least one titanium compound, the titanium compound solution can also include at least one sealing agent. The at least one sealing agent can include 0.6-5.0 g/L of nickel acetate and nickel fluoride. The anodized alloy substrate 202 is immersed in the titanium compound solution for a time period in a range of about 10-20 minutes, The titanium compound solution may be maintained at a temperature in a range of about 25-95° C.

The titanium compound solution is alkaline in nature. In an example, the titanium compound solution has a pH in a range of about 9-12. In order to maintain the pH, the titanium compound solution includes at least one alkaline agent. The at least one alkaline agent may be present in a weight percentage range of about 0.1-10%. The at least one alkaline agent can be selected from the group consisting of sodium hydroxide, potassium hydroxide, sodium phosphate, and sodium hexametaphosphate.

The immersion of the anodized alloy substrate 202 in the titanium compound solution causes entry of titanium metal complexes and titanium dioxide particles, which are smaller in size than the size of the plurality of pores, from the titanium compound solution into the plurality of pores. As the plurality of pores and the surface of the anodized alloy substrate 202 may have residual acid on them while the titanium compound solution is alkaline, titanium metal complexes and titanium dioxide particles get easily and rapidly deposited from the titanium compound solution into the plurality of pores.

The immersion also causes the sealing of the plurality of pores to form a sealed substrate 402, which may also be referred to as a processed substrate 402. As mentioned earlier, the sealing can be effected by including at least one sealing agent in the titanium compound solution and maintaining the titanium compound solution at a temperature in the range of about 25-95° C.

The sealed substrate 402 can include titanium metal complexes 404, 406, and 408, in the pores 208-1, 208-2, and 208-3, respectively. Further, the sealed substrate 402 also includes titanium dioxide particles in the plurality of pores. The sealing of the plurality of pores prevents the titanium dioxide particles and titanium metal complexes from exiting the plurality of pores.

Since the immersion of the anodized alloy substrate 202 in the titanium compound solution results both in entry of titanium dioxide particles and titanium metal complexes in the plurality of pores and the sealing of the plurality of pores, a separate sealing step can be avoided.

In another implementation, instead of immersing the anodized alloy substrate 202 in the titanium compound solution, the anodized alloy substrate 202 is spray coated with an alkaline solution including titanium dioxide. The alkaline solution may include a base, such as sodium hydroxide or potassium hydroxide, in a weight percentage range of about 1-10%, a dispersant, such as sodium polyacrylate, sodium silicate, or sodium phosphate, in a weight percentage range of about 0.1-2%, and titanium dioxide particles in a weight percentage range of about 5-30%. The spray coated substrate can then be sealed, for example, using the sealing process explained at block 314.

After sealing, the sealed substrate 402 or the spray coated substrate can be baked. The baking may be performed at a temperature in a range of about 105-110° C. for a tine period in a range of about 20-40 minutes. The baking enables removal of water from the plurality of pores and retention of just the titanium metal complexes and titanium dioxide particles in the plurality of pores. The baking results in the formation of a finished substrate 410. The finished substrate 410 includes titanium dioxide particles in the plurality of pores. For example, finished substrate 410 includes titanium dioxide particles 412, 414, and 416 in the pores 208-1, 208-2, and 208-3, respectively.

The present subject matter provides a simple, effective, and efficient method of providing titanium dioxide particles in the oxidized layer on an anodized alloy substrate, thereby making it white and substantially non-reflective. Therefore, the present subject matter can be used for alloys, such as Al 6013, that have a high tensile strength, but have a yellowish and reflective appearance post anodization to render them suitable for applications like casings for electronic devices. The present subject matter uses the difference between pH of the oxidized layer of the anodized alloy substrate and pH of the alkaline mixture to enable deposition of a large number of titanium metal complexes and titanium dioxide particles from the alkaline mixture in the pores of the oxidized layer of the anodized alloy substrate. Therefore, complex techniques, such as electrolysis, that are otherwise used for depositing particles may be avoided. Still further, the steps involved in the method, such as sealing and baking, are performed at less aggressive temperature conditions, such as below 110° C., and at normal pressure. Therefore, the methods of the present subject matter can be performed in a simple cost-effective manner.

Although implementations of treating alloy substrates having oxidized layers have been described in language specific to structural, features and/or methods, it is to be understood that the present subject matter is not necessarily limited to the specific features or methods described. Rather, the specific features and methods are disclosed and explained as example implementations.

We claim:

1. A method comprising:
contacting an anodized alloy substrate with an alkaline mixture comprising titanium to form a processed substrate, wherein the anodized alloy substrate comprises an oxidized layer on its surface; and
baking the processed substrate to form a finished substrate, wherein the finished substrate comprises titanium dioxide particles in the oxidized layer.

2. The method of claim 1, wherein the alkaline mixture comprising titanium is a slurry comprising titanium dioxide nano-particles and wherein contacting the anodized alloy substrate with the alkaline mixture comprises immersing the anodized alloy substrate in the slurry comprising titanium dioxide nano-particles.

3. The method of claim 1, wherein the alkaline mixture comprising titanium is a titanium compound solution and wherein contacting the anodized alloy substrate in the alkaline mixture comprises sealing a plurality of pores in the oxidized layer using the titanium compound solution.

4. The method of claim 1, wherein contacting the anodized alloy substrate with the alkaline mixture comprising titanium comprises spray coating a solution comprising titanium dioxide on the anodized alloy substrate.

5. The method of claim 1, wherein the alloy substrate is an aluminum alloy substrate.

6. The method of claim 1, wherein the alkaline mixture comprising titanium has pH in a range of about 8-12.

7. The method of claim 1, wherein the baking of the processed substrate is performed at a temperature in a range of about 105-110° C. for a time period in a range of about 20-40 minutes.

8. A method comprising:
anodizing an alloy substrate to form an anodized alloy substrate, the anodized alloy substrate comprising a plurality of pores in its surface; and
immersing the anodized alloy substrate in a slurry comprising titanium dioxide nano-particles to deposit titanium dioxide nano-particles in the plurality of pores, wherein the slurry is alkaline.

9. The method of claim 8, wherein the slurry comprising titanium dioxide nano-particles comprises titanium dioxide nano-particles in a range of about 5-75 weight percentage.

10. The method of claim 8, wherein the slurry comprising titanium dioxide nano-particles further comprises at least one dispersing agent selected from the group consisting of sodium silicate, sodium hexametaphosphate, sodium phosphate, sodium polyacrylate, and combinations thereof in a range of about 0.1-2 weight percentage.

11. The method of claim 8, further comprising:
sealing the anodized alloy substrate after depositing, titanium dioxide nano-particles in the plurality of pores; and
baking the sealed alloy substrate.

12. The method of claim 8, wherein the titanium dioxide nano-particles in the slurry have a size in a range of about 3-50 nm.

13. A method comprising:
forming an oxidized layer on a surface of an alloy substrate by electrolytic oxidation, the oxidized, layer comprising a plurality of pores;
sealing the plurality of pores using a titanium compound solution, the sealing forming a sealed substrate, wherein the titanium compound solution is alkaline; and
baking the sealed substrate to form a finished substrate, wherein the finished substrate comprises titanium dioxide particles in the plurality of pores.

14. The method of claim 13, wherein the titanium compound solution comprises a titanium compound in a weight percentage range of about 1-30.

15. The method of claim 13, wherein the titanum compound solution comprises at least one titanium compound selected from the group consisting of titanium dioxide, titanium hydroxide, titanium phosphate, titanium metal complex, and combinations thereof.
